(19) United States
(12) Patent Application Publication
(10) Pub. No.: US 2013/0050477 A1
(43) Pub. Date: Feb. 28, 2013

(54) DEVICE FOR SENSING, MONITORING AND TELEMETRY USING VIDEO CAMERAS FOR VISUALIZATION, BROADCAST AND RECORDING

(71) Applicant: Marcos LIMA, Botafogo-Rio de Janeiro (BR)

(72) Inventor: Marcos LIMA, Botafogo-Rio de Janeiro (BR)

(21) Appl. No.: 13/217,097

(22) Filed: Aug. 24, 2011

(51) Int. Cl. H04N 7/18

(52) U.S. Cl. 348/143; 348/E07.085

(57) ABSTRACT

An innovative integrated system destined to perform real-time sensing of a location with multiple sensors simultaneously and to proceed with telemetry, monitoring and command in its equipment and installed systems, inserting all information (data collected or actions taken) on images of a video system, to share its visualization, broadcast and recording. Includes a device, provided with internal processing elements connected to a video camera, be it digital or analog and of various types, and to sensors, also of various types and applications, through compatible input ports, be them analog and/or digital and of various types accompanied by an equal number of output ports of various types, as required. Also, optionally, there may be connected auxiliary devices such as video recorders, data communication and memory chips, among others. The data collected from sensors and internally processed by the elements is displayed in lines and/or columns on the video output. The invention herein can also be incorporated to another device, or even be a block or part of video cameras, video surveillance cameras and IP cameras, among others.

### BACKGROUND OF THE INVENTION

1. Field of the Invention

One or more embodiments setting forth the ideas described throughout this disclosure pertain to an innovative integrated system in the field of real-time sensing of a location with multiple sensors simultaneously and proceeding with telemetry, monitoring and command of equipment and installed systems, inserting all information (data collected or actions taken) on images of a video system, sharing its visualization, broadcast and recording.

2. Description of the Related Art

The state of the art referent to the matter herein is composed of a series of sensing devices, however, none of the known sensing devices have the technical characteristics according to Applicant's inventive embodiments.

Known devices that combine sensor data with images include “game cameras” which generally include motion sensing elements that enable the device to capture a picture when something moves in front of a camera. Known systems combine temperature data, and time data superimposed on the image, but do not allow for programmable text capabilities and include a fixed number of known sensors.

Specifically, the state of the art fails to facilitate the readability and programmability of text with respect to sensing devices that one or more embodiments of the invention teach herein.

### BRIEF SUMMARY OF THE INVENTION

Embodiments of the invention generally include a device, provided with internal processing elements connected to a video camera, be it digital or analog and of various types, and to sensors, also of various types and applications, through compatible input ports, be them analog and/or digital and of various types accompanied by an equal number of output ports of various types, as required. Also, optionally, there may be connected auxiliary devices such as video recorders, data communication and memory chips, among others. The data collected from sensors and internally processed by the elements is displayed in lines and/or columns on the video output.

### BRIEF DESCRIPTION OF THE DRAWINGS

The above and other aspects, features and advantages of the invention will be more apparent from the following more particular description thereof, presented in conjunction with the following drawings wherein:

FIG. 1 shows the schematic representation of an embodiment of the invention.

FIG. 2 shows the schematic representation of the sensors in the video monitor.

### DETAILED DESCRIPTION OF THE INVENTION

In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

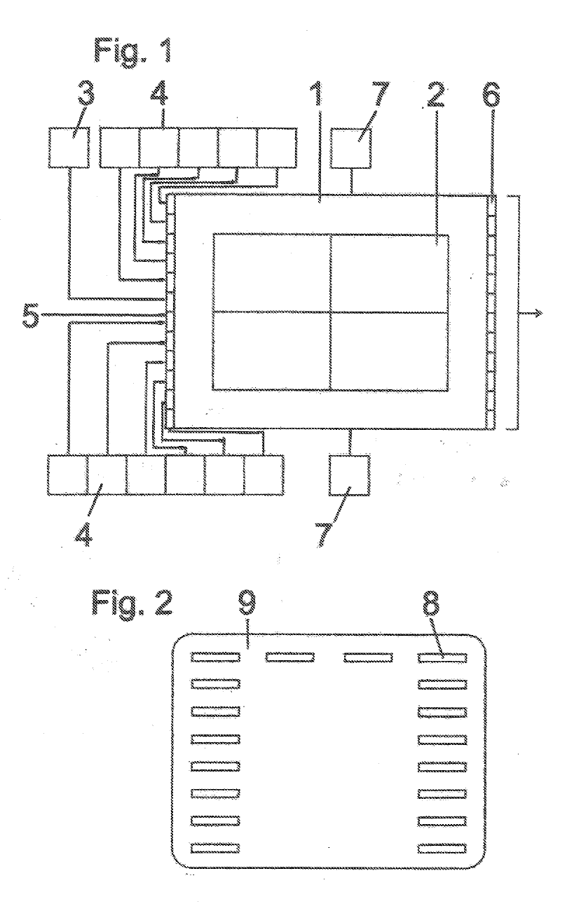

FIG. 1 shows that embodiments of the invention generally include a device (1), provided with internal processing elements (2) connected to a video camera (3), be it digital or analog and of various types, and to sensors (4), also of various types and applications, through compatible input ports (5), be them analog and/or digital and of various types accompanied by one or more output ports (6) of various types, as desired. Also, optionally, there may be connected auxiliary devices (7) such as video recorders, data communication and memory chips, among others. The data collected from sensors (4) and internally processed by the elements (2) is displayed in lines and/or columns (8) on the video output (9). One or more embodiments of the system programmatically enable the assignment of a location, i.e., line/column to data associated with a given sensor (4). This for example may be performed wirelessly or by instructing internal processing elements (2) in any other manner, as to the assignment of respective sensor data with a line/column. For example, with the advent of wireless sensors, input ports (5) may for example be implemented with wireless element(s). Hence, embodiments of device (1) may be coupled to the output of a standard video camera (d), either internally or externally, wherein any hardwired or wireless sensor data is integrated into the output video signal on at least one output port (6) and shown as in FIG. 2. In one or more embodiments of the invention, different sets output signals at the output ports (6) may include a different set of sensors signals in various lines/columns as programmed via internal processing elements (2).

Therefore, all externally collected information is processed inside device (1) and made available in “video-multimedia” format to be destined as convenient in up to N sensor data values on up to M output ports (6) in any combination. In addition, the displays may be dynamically changed over time so that the video signal at each of the output ports (6) changes as programmed. This allows for alerts or warnings to be displayed for example.

Device (1) may be a fixed or moving installation of equipment. Device (1) may also be incorporated to another device, or even be a block or part of video cameras, video surveillance cameras and IP cameras, video cable among others. Also, when applied to video equipment and systems, device (1) enables a home-based, commercial or professional service for sensing, monitoring or telemetry, connected to sensors applied to each operation.

In case device (1) is used (being connected, incorporated, being a block or a part) on an IP camera, several facilities can be aggregated to it, including the direct availability of its information on remote images via IP protocol. In this embodiment, sensors (4) may be located anywhere on the network, which allows for the display of FIG. 2 to integrate sensor data from distal locations.

Currently existing devices of similar purpose require conjugated equipment and software to work, as well as a (usually dedicated) data communication channel, for full operation. In addition, the data collected is usually transferred in codes and stored in proprietary systems, increasing the costs with maintenance/replacement and making it difficult or impossible to integrate its information with other existing information of interest for each user.

Therefore, any system expansion and/or integration results in expenses with technical consulting, feasibility studies, projects, tests and time, among so many other expenses not mentioned hereof. On the other hand, through the present device and its multiple connected sensors, it is possible to achieve the organization, visualization and control of all information sent by the process in real-time, which provides for decision-making also in real-time. Since device (1) is projected to “inject information” on the video from an operational camera, such information can be transmitted and stored without the need for a dedicated or specific system, operating instead by means of any video-monitoring, video-broadcast and video-recording available in the market, provided they are operated in joint compatibility.

While the invention herein disclosed has been described by means of specific embodiments and applications thereof, numerous modifications and variations could be made thereto by those skilled in the art without departing from the scope of the invention set forth in the claims

1) A device for sensing, monitoring and telemetry using video cameras for visualization, broadcast and recording comprising:
at least one internal processing element (2) configured to couple with a video camera (3) that is digital or analog;
sensors (4) configured to collect data that is internally processed via said internal processing elements (2);
compatible input ports (5) that are analog and/or digital;
said sensors (4) coupled with said at least one internal processing element (2) through said compatible input ports (5) that are analog and/or digital; and,
output ports (6) configured to output video data from said video camera (3) combined data from at least one of sensors (4).

2) The device of claim 1 further comprising:
auxiliary devices (7) comprising video recorders, data communication and memory chips coupled with said output ports (6).

3) The device of claim 1 wherein internal processing elements (2), are incorporated within said video camera and wherein said video camera comprises at least one video surveillance camera or at least one IP camera or both.

4) The device of claim 1 further comprising a video output comprising lines and/or columns (8), wherein the data collected from sensors (4) and internally processed by the internal processing elements (2) are displayed in said lines and/or columns (8) on the video output (9).
